(19) United States
(12) Patent Application Publication
(10) Pub. No.: US 2005/0227137 A1
(43) Pub. Date: Oct. 13, 2005

(54) Fuel-cell power plant

(75) Inventor: Sohei Suga, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/101,494

(22) Filed: Apr. 8, 2005

(30) Foreign Application Priority Data
Apr. 8, 2004 (JP) 2004-114256

(51) Int. Cl. H01M 8/04; H01M 8/10

(52) U.S. Cl. 429/34; 429/22; 429/30

(57) ABSTRACT

An anode effluent which is discharged from an anode (7) of a fuel-cell stack (1) is recirculated to the anode (7) by a recirculation passage (32, 35, 37), while a hydrogen cylinder (5) supplies hydrogen to the recirculation passage (32, 35,37). A hydrogen separator (2) separates hydrogen from a gas in the recirculation passage (32, 35, 37), and discharges the remaining gas after the hydrogen is separated to the atmosphere, whereby the hydrogen concentration in a hydrogen rich gas supplied to the anode (7) is raised. A controller (50) uses a valve (V1) to connect the recirculation passage (32, 35, 37) to the anode (7) directly or via the hydrogen separator (2), whereby the hydrogen concentration in the hydrogen rich gas is maintained in an appropriate range without discharging the hydrogen to the atmosphere.

### FIELD OF THE INVENTION

This invention relates to control of the hydrogen concentration in a hydrogen rich gas which is supplied to the anode of a fuel-cell stack.

### BACKGROUND OF THE INVENTION

A fuel-cell stack generates electricity by an electrochemical reaction of the hydrogen in a hydrogen rich gas which is supplied to the anode and atmospheric oxygen which is supplied to the cathode. After finishing a reaction on the anode, the residual gas is discharged as an anode effluent from the anode. A substantial amount of hydrogen is still contained in the anode effluent. Therefore, resupply of the anode effluent via a recirculation passage after replenishing the hydrogen into the anode effluent has been conventionally performed.

The hydrogen rich gas supplied to the anode in this case is therefore a mixture of the anode effluent and the replenished hydrogen.

In a power plant comprising such fuel-cell stack, when a non-operative state of the power plant is continued, air enters the anode of the fuel-cell stack from outside.

United States Patent Application Publication No. 2002/0076582 proposes supply of hydrogen to the anode before connecting an electrical load to the fuel-cell stack in order to start up a power plant immediately, and purging of the residual air in the anode by the hydrogen with the recirculation passage released to the air.

On the other hand, also in a normal operation of the power plant, when recirculation of the anode effluent is continued the amount of the air or nitrogen in the anode effluent is increased, and the hydrogen concentration in the hydrogen rich gas is decreased. In the prior art, therefore, portion of the anode effluent is released from the recirculation passage, thereby maintaining the hydrogen concentration of the hydrogen rich gas within a preferable range.

### SUMMARY OF THE INVENTION

In a normal operation and a start-up operation of the power plant as well, when the recirculation passage is released to the atmosphere, it is inevitable that the hydrogen is discharged together with the air or nitrogen into the air. However, discharging the hydrogen into the atmosphere is not preferred in the environment and safety aspects.

Particularly, in the fuel-cell power plant for a vehicle, hydrogen emission to the outside is not preferred, because the power plant may be started up in a closed space such as an underground parking area.

Moreover, when purging the residual air in the anode by using the hydrogen, there is a state, in the anode, in which the flowing-in hydrogen and the residual air contacts with each other via an interface. In this state, a hydrogen ion penetrated in the cathode reacts with the oxygen to produce water, and further the water may react with a carbon which supports a cathode catalyst, whereby carbon corrosion may occur easily. In order to prevent carbon corrosion, it is preferred to complete purging of the residual air in a short amount of time. However, in order to do so, the power plant needs to be equipped with a hydrogen gas supply device having a large discharge such as a high-output compressor.

It is therefore an object of this invention to prevent the hydrogen from flowing out to the outside of the power plant and corrosion of the carbon that supports a catalyst during purging of the residual air and anode effluent in the recirculation passage.

In order to achieve the above object, this invention provides a fuel-cell power plant comprising a fuel-cell stack which generates electricity by an electrochemical reaction of hydrogen which is supplied to an anode and an oxidant which is supplied to a cathode, a hydrogen supply device which supplies hydrogen to the anode, a recirculation passage which recirculates an anode effluent discharged from the anode, to the anode, and a hydrogen separator disposed in the recirculation passage to separate hydrogen from the anode effluent. The hydrogen separator comprises a discharge passage for discharging the anode effluent after separation of hydrogen to the outside of the power plant.

The power plant further comprises a bypass flow passage which detours the hydrogen separator and directly connects the recirculation passage to the anode, and a valve which selectively connects the recirculation passage to the hydrogen separator and to the bypass flow passage.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel-cell power plant according to this invention.

FIG. 2 is a flow chart for explaining a start-up control routine of a fuel-cell power plant which is executed by a controller according to this invention.

FIG. 3 is a flow chart for explaining a normal start-up control sub-routine of the fuel-cell power plant executed by the controller.

FIG. 4 is a flow chart for explaining a start-up control sub-routine executed by the controller when the power plant has not been operative for a long time.

FIG. 5 is a flow chart for explaining an air purge control routine executed by the controller during a normal operation of the fuel-cell power plant.

FIG. 6 is a flow chart for explaining a hydrogen replacement routine performed by a controller according to a second embodiment of this invention when the fuel-cell power plant stops operating.

FIG. 7 is a schematic diagram of a fuel-cell power plant according to a third embodiment of this invention.

FIG. 8 is a graph showing a relationship between an inlet pressure and outlet pressure of an ejector according to the third embodiment of this invention.

FIG. 9 is a graph showing a relationship between a nitrogen concentration of inflow gas of the ejector and an ejector efficiency according to the third embodiment of this invention.

FIG. 10 is a flow chart for explaining an air purge control routine performed by a controller according to the third embodiment of this invention during a normal operation of the fuel-cell power plant.

FIGS. 11A and 11B are schematic longitudinal sectional views of a fuel cell explaining chemical reactions occurring in the fuel cell when a fuel-cell power plant according to a prior art begins to operate.

### DESCRIPTION OF THE PREFERRED EMBODIMENTS

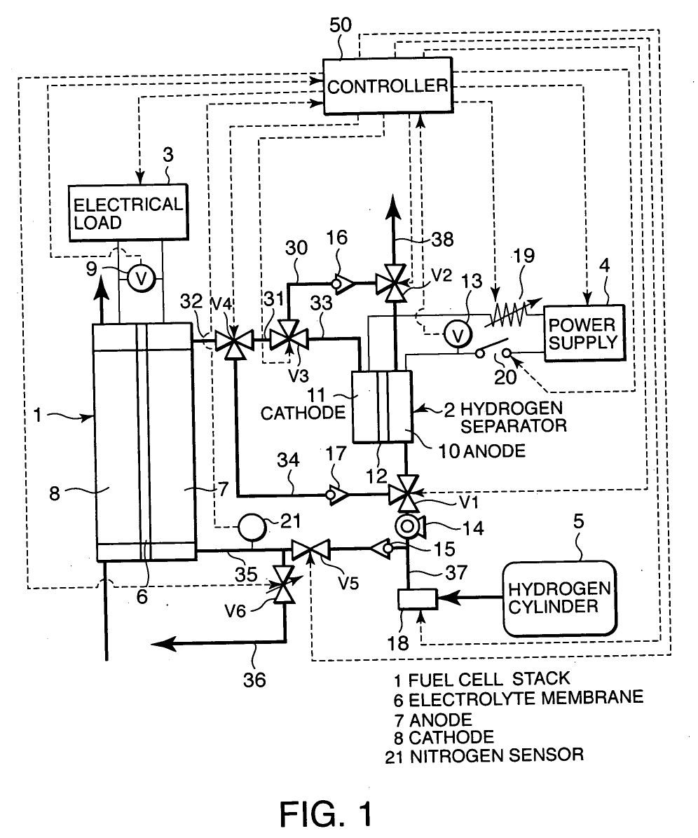

Referring to FIG. 1 of the drawings, a fuel-cell power plant according to this invention comprises a fuel-cell stack 1 which supplies an electric power to a electrical load 3, a hydrogen separator 2, a direct current supply device 4 which supplies an electric power to the hydrogen separator 2, and a hydrogen cylinder 5 which supplies hydrogen to the fuel-cell stack 1 and hydrogen separator 2. The fuel-cell stack 1 is composed of numbers of fuel cells that are stacked.

Each of the fuel cells comprises a solid polymer electrolyte membrane 6, and an anode 7 and cathode 8 disposed on both sides thereof. In each of the fuel cells, hydrogen is supplied from the hydrogen cylinder 5 or the hydrogen separator 2 to the anode 7.

Further, an anode effluent is resupplied from a flow passage 35 to the anode 7. The gas supplied to the anode 7 includes a large quantity of hydrogen, thus the gas supplied to the anode 7 is termed “hydrogen rich gas” in explanations hereinafter.

Air is supplied to the cathode 8 from an air supply device constructed from an air compressor and the like.

The fuel cell generates electricity by an electrochemical reaction of the hydrogen in the hydrogen rich gas supplied to the anode 7 and the atmospheric oxygen supplied to the cathode 8, the electrochemical reaction occurring via the polymer electrolyte membrane 6.

Hydrogen and anode effluent are supplied to the hydrogen separator 2 from the hydrogen cylinder 5 and the anode 7 of the fuel-cell stack 1 respectively. The hydrogen separator 2 comprises an anode 10 which separates the hydrogen in the gas into protons under power supply, a cathode 11 which reduces the protons obtained by the separation in the anode 10 to hydrogen again, and a solid polymer electrolyte membrane 12 which moves the proton obtained by the separation in the anode 10 to the cathode 11. The gas supplied to the anode 10 is termed a “hydrogen-containing gas” in the explanation hereinafter.

The anode 10 comprises a hydrogen oxidation catalyst, and the cathode 11 comprises an oxidation-reduction catalyst. A platinum-supported carbon black or platinum black is used for these catalysts.

Although the platinum-supported carbon black provides a large surface area of platinum with a small usage of platinum, carbon corrosion occurs easily. Since the hydrogen separator 2 may be of a small capacity, the required amount of platinum is still small even when the platinum black is used.

For the above reason, the platinum black is used as the catalysts in the hydrogen separator 2 in this embodiment.

A perfluorocarbon sulfonic acid ionomer having a proton conductivity, such as Nafion®, is used for the solid polymer electrolyte membrane 12. When such material is used for the solid polymer electrolyte membrane 12, the thickness of the hydrogen separator 2 can be thinned, and the fuel-cell power plant can be miniaturized. On the other hand, by increasing the thickness of the solid polymer electrolyte membrane 12, durability of the hydrogen separator 2 can be improved.

Next, a function of the hydrogen separator 2 will be described.

When a connection is made between the anode 10 of the hydrogen separator 2 and the positive electrode of the direct current supply device 4, and between the cathode 11 of the hydrogen separator 2 and the negative electrode of the direct current supply device 4, to supply an electric current, if hydrogen is present in the anode 10, a reaction represented by the following formula (1) occurs in the anode 10.
H₂→2H⁺+2e⁻ (1)

The protons generated in the formula (1) permeate the solid polymer electrolyte membrane 12 to reach the cathode 11. As a result, when oxygen is present in the cathode 11, a reaction represented by the following formula (2) occurs.
2H⁺+½.O₂+2e⁻→H₂O (2)

As a result of the reaction of the formula (2), when the oxygen no longer exists in the cathode 11, the protons generated in the anode 10 initiate a reaction represented by the following formula (3) in the cathode 11 to generate hydrogen.
2H⁺+2e⁻→H₂ (3)

The reactions of the formulae (1) and (3) indicate that the hydrogen in the anode 10 moves to the cathode 11. By these reactions, the hydrogen ions in the hydrogen-containing gas supplied to the anode 10 can be separated and reduced to hydrogen in the cathode 11.

The movement of the hydrogen, which is caused by the above reactions that the hydrogen separator 2 initiates in response to supply of a direct current from the direct current supply device 4, is generally called “hydrogen pump”. The movement of the hydrogen by the hydrogen pump is performed by passing a direct current to the hydrogen separator 2 from the direct current supply device 4 so as to reduce an electric potential of the cathode 11, when, for example, the anode 10 which introduces hydrogen is taken as a reference electrode and the cathode 11 as a work electrode. The movement distance of the hydrogen at that moment is represented by the following formula (4).

$$[ {H}_{2} ] = \frac{l}{2} \cdot F \qquad ( 4 )$$

[H₂] is a molar flow velocity (mol/sec), / is a current (coulomb/sec), and F is a Faraday constant (coulomb/mol). As shown in the formula (4), the movement distance of the hydrogen is proportional to the electric current.

The cathode 11 of the hydrogen separator 2 is filled with hydrogen at normal times. For this reason, if a gas containing a substance other than hydrogen is present in the anode 10, a unique potential difference occurs between the anode 10 and the cathode 11. When the gas present in the anode 10 only contains hydrogen, no potential difference occurs between the anode 10 and the cathode 11. An electromotive force E of the hydrogen separator 2 which is equivalent to the potential difference between the anode 10 and the cathode 11 is represented by the following formula (5) where the cathode 11 is a reference electrode.

$$E = \frac{R \cdot T}{2 \cdot F} \cdot ln K + \frac{R \cdot T}{2 \cdot F} \cdot ln ( \frac{{PH}_{2} \cdot {PO}_{2} \cdot \frac{1}{2}}{{PH}_{2} O} ) ] \qquad ( 5 )$$

where, R=gas constant,
T=temperature,
K=equilibrium constant,
F=Faraday constant,
PH₂=partial pressure of hydrogen in the cathode 11,
PO₂=partial pressure of oxygen in the anode 10, and
PH₂O=partial pressure of water vapor in the anode 10.

When wet conditions of the anode 10 and the cathode 11 are equal, the solid polymer electrolyte membrane 12 does not let an oxygen ion penetrate therethrough. Under this condition, by supplying hydrogen from the hydrogen cylinder 5 to the anode 10 such that the partial pressure of hydrogen becomes one atmosphere (atm), and supplying an electric current from the direct current supply device 4 to the anode 10 and the cathode 11, it is possible to separate only hydrogen from the hydrogen-containing gas in the anode 10 containing hydrogen and air through the solid polymer electrolyte membrane 12 and extract it from the cathode 11. The gas remaining in the anode 10 other than the hydrogen is discharged to the outside.

The fuel-cell power plant comprises a voltmeter 13 for executing a potential difference E of the anode 10 and of the cathode 11 of the hydrogen separator 2. A potential difference E detected by the voltmeter 13 in a state where supply of an electric current from the direct current supply device 4 to the hydrogen separator 2 is stopped and both of the anode 10 and cathode 11 are filled with hydrogen, is zero volt, which is a theoretical electromotive force of hydrogen.

When an inert gas other than the hydrogen is present in the anode 10 while the cathode 11 is filled with hydrogen, the electric potential of the anode 10 becomes low with respect to that of the cathode 11. Therefore, when the cathode 11 is filled with hydrogen, the hydrogen concentration in the hydrogen-containing gas supplied to the anode 10 can be found out by detecting a potential difference E between the anode 10 and the cathode 11 in a state where supply of an electric current from the direct current supply device 4 to the hydrogen separator 2 is stopped.

The direct current supply device 4 for supplying an electric current to the hydrogen separator 2 is constructed from a secondary battery such as a lead storage battery. The fuel-cell power plant comprises a load adjusting device 19 for adjusting an electric current supplied from the direct current supply device 4 to the hydrogen separator 2, and a power switch 20 for switching between execution and stop of supply of an electric current to the hydrogen separator 2. The fuel-cell power plant further comprises a voltmeter 9 which detects a generator electrical voltage of the fuel-cell stack 1.

Next, a configuration of a passage which connects the hydrogen cylinder 5, hydrogen separator 2, and anode 7 of the fuel-cell stack 1 will now be explained.

The fuel-cell power plant comprises flow passages 30 to 33, a bypass flow passage 34, flow passages 35 and 37, discharge passages 36 and 38, and three way valves V1 to V4.

The hydrogen cylinder 5 is connected to the anode 10 of the hydrogen separator 2 via the flow passage 37. The three way valve V1 selectively connects the flow passage 37 to the anode 10 of the hydrogen separator 2 and the bypass flow passage 34 which reaches the three way valve V4.

The three way valve V2 selectively connects the discharge passage 38 which is released to the air to the anode 10 of the hydrogen separator 2 and the flow passage 30 which reaches the three way valve V3.

The flow passage 33 is connected to the cathode 11 of the hydrogen separator 2. The three way valve V3 selectively connects the flow passage 33 to the flow passage 31 reaching the flow passage 30 and the three way valve V4.

The flow passage 32 is connected to the anode 7 of the fuel-cell stack 1. The three way valve V4 selectively connects the flow passage 31 to the flow passage 32 and the bypass flow passage 34.

The flow of the gas in the flow passage 30 connecting the three way valves V2 and V3 is limited, by a check valve 16, to the direction going from the three way valve V2 to the three way valve V3. The flow of the gas in the bypass flow passage 34 which connects the three way valves V1 and V4 is limited, by a check valve 17, to the direction going from the three way valve V1 to the three way valve V4.

The flow passage 35 connects the anode 7 of the fuel-cell stack 1 to the flow passage 37. The flow passage 35 is further connected to the discharge passage 36, which is released to the atmosphere, via a flow control valve V6. The flow passage 35 is provided with a shutoff valve V5 and a check valve 15 for blocking a gas flowing from the flow passage 37 to the anode 7.

The fuel-cell power plant further comprises a blower 14, which promotes the flow of the gas in a section from a merging point of the flow passage 37 with the flow passage 35 to the three way valve V1, and a mass flow control valve 18, which adjusts the amount of hydrogen supplied from the hydrogen cylinder 5 to the flow passage 37, between the hydrogen cylinder 5 and the merging point of the flow passage 35 in the flow passage 37. The fuel-cell power plant further comprises a nitrogen sensor 21 which detects a nitrogen concentration in the anode effluent discharged from the anode 7 to the flow passage 35.

Under the above configuration, the fuel-cell power plant, in a normal generating operation, supplies the hydrogen, which is supplied from the hydrogen cylinder 5 to the flow passage 37, to the anode 7 of the fuel-cell stack 1 via the three way valve V1, bypass flow passage 34, three way valve V4, and flow passage 32. After the electrochemical reaction in the anode 7, the anode effluent which is discharged from the anode 7 to the flow passage 35 is recirculated to the flow passage 37, and is mixed with fresh hydrogen which is supplied from the hydrogen cylinder 5.

As described hereintofore, the resultant gas is termed as the hydrogen-containing gas. The hydrogen separator 2 transmits only hydrogen from the hydrogen-containing gas to the cathode 11 via the solid polymer electrolyte membrane 12. The hydrogen of the cathode 11 is supplied to the anode 7 of the fuel-cell stack 1 via the flow passage 33, three way valve V3, flow passage 31, three way valve V4, and flow passage 32.

The flow passages 32, 35, and 37 among the above flow passages 30 to 35 and 37 correspond to the recirculation passage in the claims. The bypass flow passage 34 corresponds to the bypass flow passage in the claims. The three way valve V1 corresponds to the valve in the claims.

The fuel-cell power plant purges the residual air in the anode 7 at the time of start-up without discharging the hydrogen to the outside as much as possible.

For this purpose, the fuel-cell power plant comprises a controller 50 which performs each operation of the three way valves V1 to V4, shutoff valve V5, flow control valve V6, and mass flow control valve 18, control of an output electric current from the direct current supply device 4 via the load adjusting device 19, and consumption current control of the electrical load 3. Detected data of the voltmeters 9 and 13 and the nitrogen sensor 21 are input to the controller 50 via signal circuits respectively.

The controller 50 is formed from a microcomputer comprising a central processing unit (CPU), read-only memory (ROM), random access memory (RAM), and input/output interface (I/O interface). The controller may also be formed from a plurality of microcomputers.

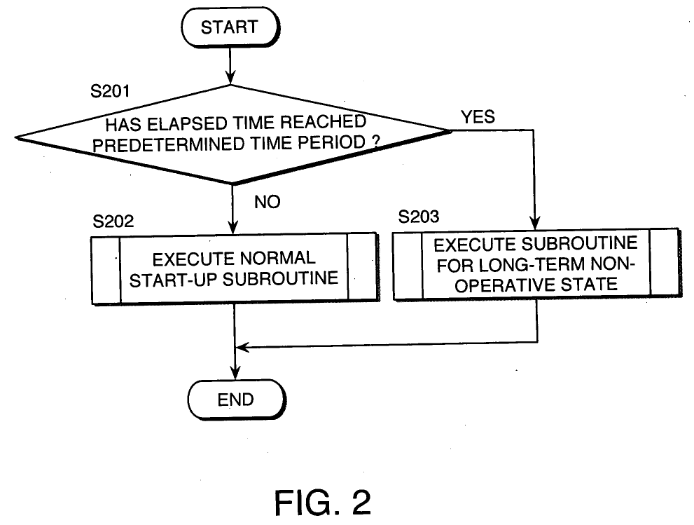

Next, referring to FIG. 2, a start-up control routine which is executed by the controller 50 at the time of start-up of the fuel-cell power plant will now be described. This routine is executed only once at the time of start-up of the fuel-cell power plant.

The controller 50 first detects a time elapsed since the previous shutdown operation, i.e. a non-operative state duration by means of a timer in a step S201, and, when the elapsed time has not reached a predetermined time, a normal start-up sub-routine is executed in a step S202, and, when the elapsed time has reached the predetermined time, a start-up sub-routine for a long-term non-operative state is executed in a step S203. A clock function of the microcomputer constituting the controller 50 is used as the timer.

The predetermined time used in the step S201 is set in advance in the following method.

Specifically, in a state where the power plant is not operative, the hydrogen concentration in the atmosphere of the anode 7 of the fuel-cell stack 1 is first regulated to 100 percent, and an elapsed time until the hydrogen concentration drops to 40 percent is measured. The measured time is set as the predetermined time.

In the determination of the step S201, instead of comparing the elapsed time since the previous shutdown operation of the power plant with the predetermined time, the hydrogen concentration of the atmosphere of the anode 7 may be detected by using the sensor to determine whether or not the hydrogen concentration is 40 percent or below.

The controller 50 finishes the routine after the processings of the step S202 or step S203.

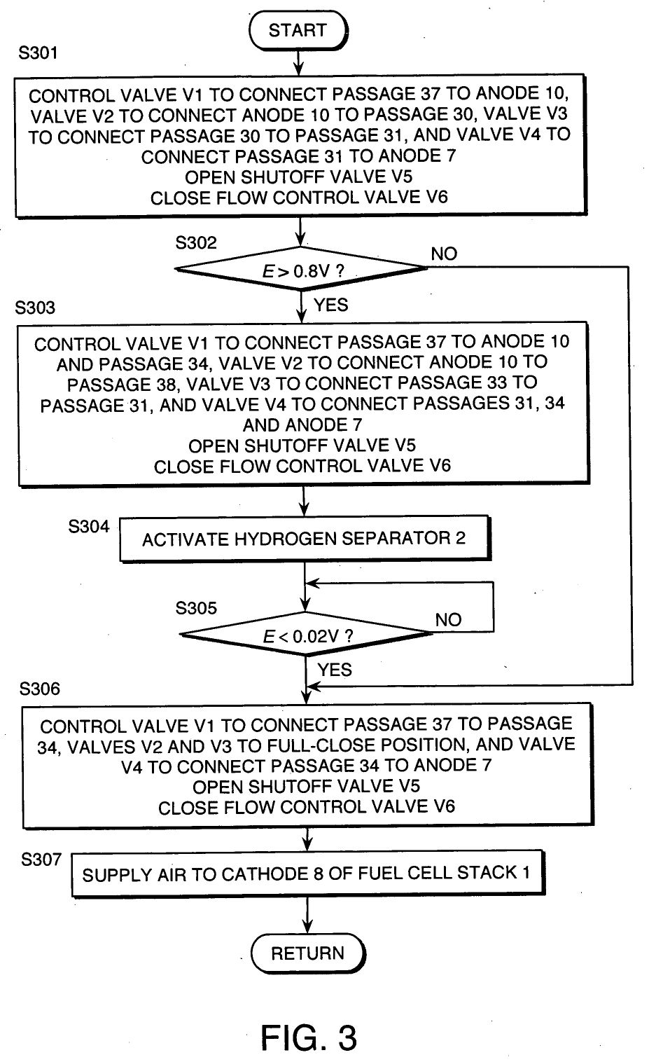

Next, referring to FIG. 3, a normal start-up sub-routine which is executed by the controller 50 in the step S202 will be described

This sub-routine is execute when the non-operative state duration is short such that less air is present in the anode 7.

The controller 50 first operates the valves V1 to V6 in a step S301 as follows.

Specifically, the three way valve V1 is operated to connect the hydrogen cylinder 5 to the anode 10 of the hydrogen separator 2, and the three way valve V2 is operated to connect the anode 10 of the hydrogen separator 2 to the flow passage 30. The anode effluent is prevented from being discharged from the anode 10 to the outside by these operations.

Further, the controller 50 operates the three way valve V3 to connect the flow passage 30 to the flow passage 31.

The controller 50 operates the three way valve V4 and connects the flow passage 31 to the anode 7 of the fuel-cell stack 1. Furthermore, the controller 50 opens the shutoff valve V5 and closes the flow control valve V6 to connect the flow passage 35 to the flow passage 37. In this state, the controller 50 starts supplying hydrogen from the hydrogen cylinder 5 and operates the blower 14.

By this processing of the controller 50, hydrogen is supplied from the hydrogen cylinder 5 to the anode 10 of the hydrogen separator 2. Moreover, the anode effluent which is discharged from the anode 7 is also supplied to the anode 10.

Since the power switch 20 is off, an electric current is not supplied from the direct current supply device 4 to the hydrogen separator 2.

In a step S302, the controller 50 compares a potential difference E between the anode 10 and cathode 11 with 0.8 volt, the potential difference E being detected by the voltmeter 13. As described above, since the only hydrogen which was transmitted through the solid polymer electrolyte membrane 12 is present in the cathode 11, the potential difference E depends on the hydrogen concentration in the hydrogen-containing gas in the anode 10.

The hydrogen-containing gas is a mixture of the hydrogen supplied from the hydrogen cylinder 5 and the anode effluent which flows from the flow passage 35 into the flow passage 37.

When a large amount of air enters the anode 7 of the fuel-cell stack 1 during a non-operative state of the fuel-cell power plant, anode effluent that flows from the anode 7 of the fuel-cell stack 1 into the flow passage 37 via the flow passage 35 after the power plant is started up is composed mainly of air. Therefore, the hydrogen concentration in the hydrogen-containing gas supplied to the anode 10 of the hydrogen separator 2 after the start-up is low.

As described hereintofore, the lower the hydrogen concentration in the hydrogen-containing gas in the anode 10, the larger the potential difference E detected by the voltmeter 13 is.

If the hydrogen concentration exceeds a hydrogen concentration which corresponds to the potential difference of 0.8 volt, it means that a large amount of the residual air exists in the anode 7, thus it is determined that purging is required. The claimed first hydrogen concentration corresponds to the hydrogen concentration in the anode effluent which produces a 0.8 volt potential difference between the anode 10 and the cathode 11.

As a result of the comparison, when the potential difference E does not exceed 0.8 volt, the controller 50 determines that the residual air in the anode 7 is limited, and performs the processing of a step S306. When the potential difference E exceeds 0.8 volt, the controller 50 determines that a large amount of the residual air exists in the anode 7, and therefore performs the processing of a step S303 to purge this residual air.

In the step S303, the controller 50 opens the three way valve V1 in all directions, in other words, sets the valve position of the three way valve V1 to a position in which the flow passage 37 communicates with both the anode 10 and the bypass flow passage 34.

At the same time the controller 50 operates the three way valve V2 such that the anode 10 is connected to the discharge passage 38 so as to discharge the anode effluent from the anode 10 to the outside without recirculation.

At the same time the controller 50 operates the three way valve V3 to connect the flow passage 33 to the flow passage 31.

At the same time the controller 50 opens the three way valve V4 all directions, in other words, sets the valve position of the three way valve V1 to a position in which the flow passage 31, the bypass flow passage 34 and the anode 7 communicate with one another.

Furthermore the controller 50 opens the mass flow control valve 18 to start supplying hydrogen from the hydrogen cylinder 5.

Accordingly, a hydrogen-containing gas which is a mixture of the hydrogen supplied from the hydrogen cylinder 5 with the anode effluent discharged from the anode 7 flows into the bypass flow passage 34 and anode 10 by the three way valve V1. On the other hand, the anode effluent discharged from the anode 10 is discharged from the discharge passage 38 into the atmosphere. The hydrogen-containing gas which passes through the bypass flow passage 34 and the hydrogen flowing out of the cathode 11 merge at the three way valve V4.

Next, in a step S304, the controller 50 switches the power switch 20 to ON to supply an electric current from the direct current supply device 4 to the hydrogen separator 2, and causes the hydrogen separator 2 to function as the hydrogen pump. The controller 50 controls the output electric current from the direct current supply device 4 via the load adjusting device 19, based on the potential difference E between the anode 10 and cathode 11 detected by the voltmeter 13, such that the potential difference E becomes 1.2 volt or less which does not cause the hydrogen separator 2 to deteriorate.

The positive electrode of the direct current supply device 4 is connected to the anode 10, and the negative electrode of same is connected to the cathode 11, whereby the hydrogen ion in the hydrogen-containing gas in the anode 10 is separated by a hydrogen pump effect of the hydrogen separator 2, and moves to the cathode 11. The residual air in the anode 10 is discharged from the discharge passage 38. The hydrogen ion is reduced in the cathode 11 to become hydrogen, passes through the flow passages 33, 31, and 32, and is supplied to the anode 7 of the fuel-cell stack 1.

Specifically, the hydrogen separator 2 separates only the hydrogen ion in the hydrogen-containing gas and discharges the residual air, thereby supplying the hydrogen rich gas to the anode 7 of the fuel-cell stack 1. The three way valve V1 diverts a part of the hydrogen-containing gas in the flow passage 37 to the bypass flow passage 34 in a position upstream of the hydrogen separator 2.

This hydrogen-containing gas is also supplied to the anode 7 of the fuel-cell stack 1 via the three way valve V4. However, the hydrogen-containing gas which is not diverted to the bypass flow passage 34 is purified to the hydrogen rich gas in the hydrogen separator 2, and is thereafter supplied to the anode 7, thus the hydrogen concentration of the gas supplied to the anode 7 increases as the hydrogen separator 2 continues acting as the hydrogen pump. In response to the progress of the hydrogen pump action, the potential difference E between the anode 10 and cathode 11 decreases.

In a next step S305, the controller 50 repeats switching the power switch 20 ON and OFF, and reads a potential difference E between the anode 10 and cathode 11, which is detected by the voltmeter 13, when the power switch 20 is OFF. The controller 50 compares this potential difference E with 0.02 volt.

When the potential difference E is 0.02 volt or above, the controller 50 turns on the power switch 20 for a certain period of time. Thereafter, the controller 50 repeats switching the power switch 20 ON and OFF to again compare the potential difference E obtained when the power switch 20 is OFF with 0.02 volt. The controller 50 repeats the processing at intervals of a certain period of time until the potential difference E falls below 0.02 volt.

The processing of the step S305 has the significance as described below. Specifically, the air remaining in the anode 7 of the fuel-cell stack 1 or the bypass flow passage 34 is, as a result of the processings in the steps S303 and S304, discharged to the flow passage 35 and merges with the hydrogen in the flow passage 37. Therefore, the hydrogen-containing gas supplied to the anode 10 of the hydrogen separator 2 has a high concentration of the air, and thus has a low concentration of the hydrogen.

However, the air remaining in the anode 7 or bypass flow passage 34 is replaced with the hydrogen rich gas as the hydrogen pump function of the hydrogen separator 2 is continued, and as a result, the hydrogen concentration in the anode effluent merging from the flow passage 35 to the flow passage 37 increases.

As a result, the hydrogen concentration in the hydrogen-containing gas supplied to the anode 10 of the hydrogen separator 2 increases, in response to which the potential difference E between the anode 10 and cathode 11 decreases.

In the step S305, it is determined that purging the residual air in the anode 7 and the bypass flow passage 34 is completed when the potential difference E falls below 0.02 volt. The second hydrogen concentration in the claims corresponds to the hydrogen concentration of the anode effluent from the anode 7 which provides a potential difference of 0.02 volt between the anode 10 and cathode 11. The potential difference E that defines the second hydrogen concentration is not limited to 0.02 volt and can be set for example to a value in the vicinity of 0.1 volt.

It should be noted that, during the time when the hydrogen separator 2 is caused to act as the hydrogen pump, the anode effluent discharged from the hydrogen separator 2 is discharged into the air from the discharge passage 38. In order to prevent the discharge of hydrogen from the discharge passage 38, it is necessary to securely separate the hydrogen which is contained in the hydrogen-containing gas supplied to the anode 10.

Therefore, it is preferable to control the load adjusting device 19 such that an electric current supplied to the hydrogen separator 2 increases when the power switch 20 is turned on for a certain period of time as the potential difference E approaches 0.02 volt.

When the potential difference E falls below 0.02 volt in the step S305, the controller 50 performs the processing of a step S306. Further, when the potential difference E did not exceed 0.8 volt in the step S302, the controller 50 skips the purging process of the steps S303 to S305 to perform the processing of the step S306.

In the step S306, the controller 50 operates the three way valve V1 such that the flow passage 37 is connected to the bypass flow passage 34 only. At the same time the controller 50 operates the three way valve V4 such that the bypass flow passage 34 communicates with only the anode 7 of the fuel-cell stack 1.

Further, the controller operates the three way valves V2 and V3 respectively to a full-close position, opens the shutoff valve V5 and closes the flow control valve V6. Herein, the full-close position realizes a state in which the three ports of the three way valve are fully closed and do not communicate with each other.

By this operation, the whole amount of the hydrogen supplied from the hydrogen cylinder 5 to the flow passage 37 and the anode effluent recirculated from the flow passage 35 to the flow passage 37 bypasses the hydrogen separator 2, and is directly supplied from the bypass flow passage 34 to the anode 7 of the fuel-cell stack 1. Here, the three way valve V1, bypass flow passage 34, three way valve V4, flow passage 32, and flow passage 35 constitute the claimed recirculation passage.

In a step S307, the controller 50 supplies air to the cathode 8 of the fuel-cell stack 1, and generation of electricity by the fuel-cell stack 1 is started.

Thereafter, the controller terminates the sub-routine as well as the routine of FIG. 2, and proceeds with a normal operation of the fuel-cell power plant.

As a result of abovementioned control performed by the controller 50, the residual air in the anode 7 of the fuel-cell stack 1 can be replaced with hydrogen quickly without discharging the hydrogen to the outside when starting the fuel-cell power plant.

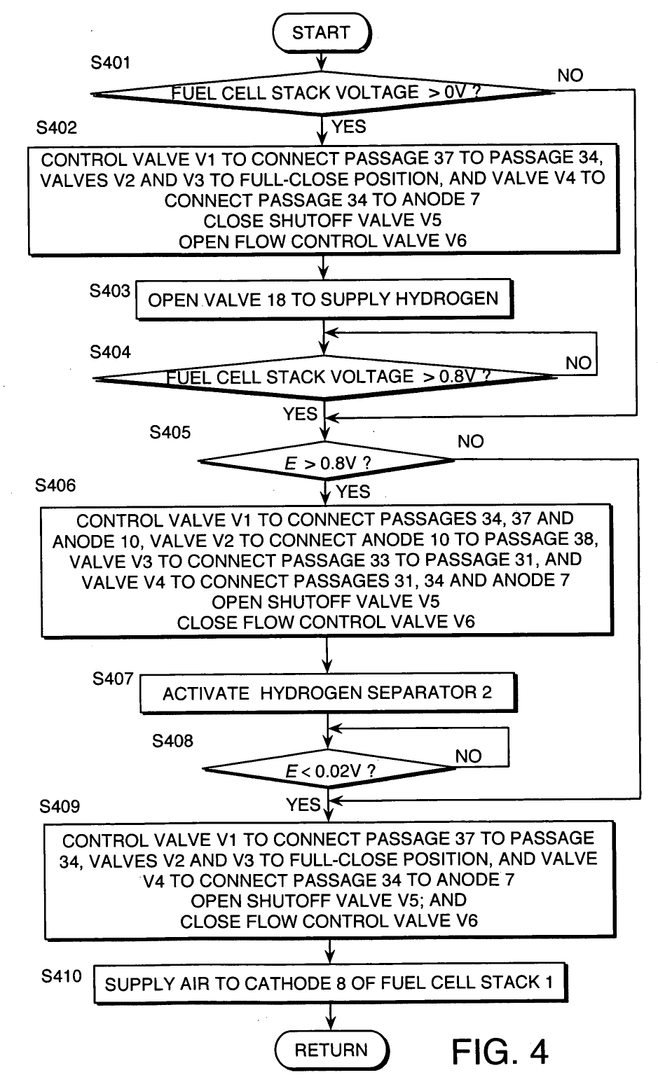

Next, referring to FIG. 4, a start-up control sub-routine for a long-term non-operative state which is executed in the step S202 in FIG. 2, will now be described.

When the elapsed time has reached the predetermined time in the step S201 in FIG. 2, the controller 50 considers that a large quantity of air remains inside the anode 7 of the fuel-cell stack 1, and performs start-up control for a long-term non-operative state below.

In a first step S401, the controller 50 determines whether or not the potential difference between the anode 7 and cathode 8 of the fuel-cell stack 1, which is detected by the volt meter, is 0 volt. When the potential difference is 0 volt, the controller 50 determines that the anode 7 is filled with air, and performs the processing of a step S402. When the potential difference between the anode 7 and cathode 8 is not 0 volt, the controller 50 determines that the hydrogen remains inside the anode 7, and performs the processing of a step S405.

In the step S402, the controller 50 operates the three way valve V1 so as to connect the hydrogen cylinder 5 to the bypass flow passage 34, and operates the three way valve V4 so as to connect the bypass flow passage 34 to the flow passage 32. At the same time the controller 50 closes the shutoff valve V5 and opens the flow control valve V6. At the same time the controller 50 operates the three way valves V2 and V3 to their respective full-close positions.

In a next S403, the controller 50 opens the mass flow control valve 18 and supplies hydrogen from the hydrogen cylinder 5 to the anode 7 via the flow passages 37, 34 and 32. The residual air in the anode 7 is discharged to the outside from the discharge passage 36. By this operation, some of the residual air inside the anode 7 is replaced with hydrogen, and the air eliminated from the anode 7 is discharged from the discharge passage 36 into the atmosphere.

In a next step S404, the controller 50 compares the potential difference between the anode 7 and cathode 8, detected by the voltmeter 9, to 0.8 volt. When the potential difference is at least 0.8 volt, it indicates that a certain quantity of hydrogen is present inside the anode 7. In this case the controller 50 performs the processing of a S405.

When the potential difference falls below 0.8 volt, the controller 50 repeats the determination of the step S404 while continuing supply of hydrogen from the hydrogen cylinder 5 to the anode 7 and discharge of the air from the discharge passage 36. When the potential difference becomes 0.8 volt or above in the step S404, the controller 50 performs the processing of the step S405.

Since the processings of steps S405 to S410 are the same as the processings of the steps S302 to S307 in FIG. 3, the explanations thereof are omitted.

In the sub-routine of FIG. 4, first of all, hydrogen is directly supplied from the hydrogen cylinder 5 to the anode 7 and the residual air in the anode 7 is purged until the potential difference between the anode 7 and cathode 8 of the fuel-cell stack 1 exceeds 0.8 volt. Therefore, even after a long-term non-operative state, the residual air in the anode 7 can be replaced with hydrogen promptly, and in a short period of time the fuel-cell stack 1 can enter a state where electricity can be generated.

Although the air eliminated from the anode 7 is discharged from the discharge passage 36 into the atmosphere, since the air discharged at this moment from the anode 7 has a very small content of hydrogen, it is not a problem to discharge the air into the atmosphere at this stage.

On the other hand, when the potential difference between the anode 7 and cathode 8 exceeds 0.8 volt, the flow control valve V6 is closed, and all of the anode effluent discharged from the anode 7 thereafter recirculates to the flow passage 37.

In this state, the hydrogen separator 2 separates the hydrogen from the hydrogen-containing gas, which is a mixture of the anode effluent and the hydrogen from the hydrogen cylinder 5, and supplies separated hydrogen to the anode 7, and only the remaining gas is discharged to the atmosphere from the emission passage 38. Therefore, it is possible to prevent the hydrogen from being discharged to the atmosphere while maintaining the hydrogen concentration in the hydrogen rich gas supplied to the anode 7 within a preferable range.

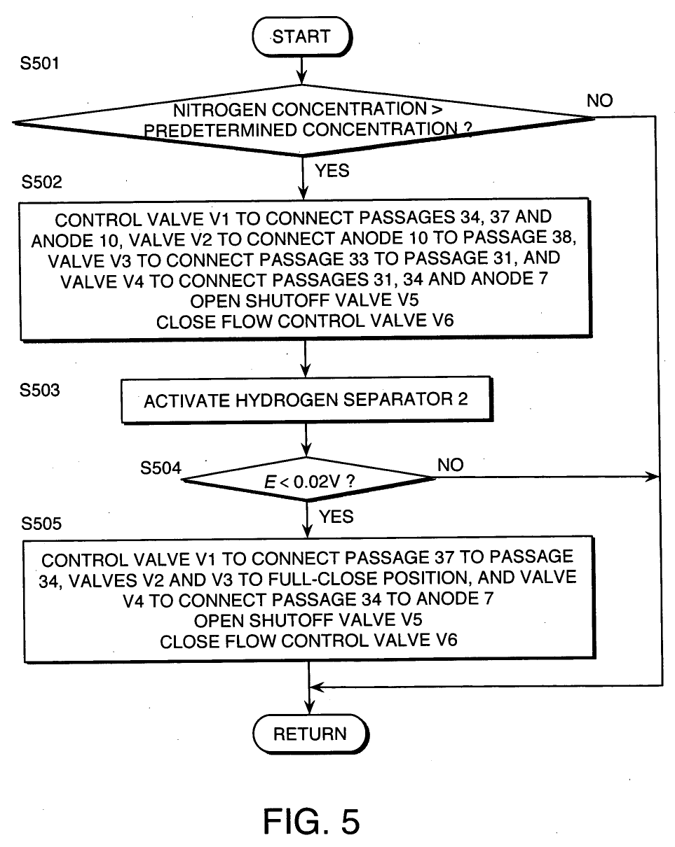

Next, referring to FIG. 5, an air purge control routine executed by the controller 50 when the air concentration in the hydrogen rich gas supplied to the anode 7 of the fuel-cell stack 1 becomes high during a normal operation of the fuel-cell power plant, will be described.

It should be noted that the greater part of the air is consisted of nitrogen, thus the concentration of the air is represented by the nitrogen concentration.

The air purge control routine during a normal operation of the fuel-cell power plant shown in FIG. 5 is a routine that is independent from the start-up control routine, and is executed by the controller 50 at intervals of 10 milliseconds during a normal operation of the fuel-cell power plant.

In the fuel-cell power plant during a normal operation, the three way valve V1 connects the flow passage 37 to the bypass flow passage 34, and the three way valve V4 connects the bypass flow passage 34 to the flow passage 32. The shutoff valve V5 is opened, and the flow control valve V6 is closed. The hydrogen supplied from the hydrogen cylinder 5 bypasses the hydrogen separator 2 and is directly supplied to the anode 7 of the fuel-cell stack 1.

The anode effluent discharged from the anode 7 passes through the flow passage 35 and the three way valve V1, is mixed with the hydrogen in the flow passage 37, and is supplied to the anode 7 again. The three way valve V2 connects the anode 10 to the flow passage 30, and the three way valve V3 connects the flow passage 30 to the cathode 11.

It is however possible to operate the three way valves V2 and V3 to the full-close position. These states described above are the same as those that are set right before a shift is made to a normal operation in the step S306 in FIG. 3 and the step S409 in FIG. 4.

In a step S501, the controller 50 compares the nitrogen concentration in the anode effluent discharged from the anode 7 of the fuel-cell stack 1 with a predetermined concentration, the nitrogen concentration being detected by the nitrogen sensor 21.

When the nitrogen concentration is higher than the predetermined concentration, the processing of a step S502 is performed. When the nitrogen concentration is not higher than the predetermined concentration, the controller 50 immediately terminates the routine. The predetermined concentration is a concentration which is set such that the electric generation efficiency of the fuel-cell stack 1 does not fall below a preferred predetermined efficiency, and is set by an experiment or simulation in advance.

Since the processings of steps S502 to S505 are the same as those of the steps S303 to S306 in FIG. 3, the explanations thereof are omitted. However, unlike the sub-routine of FIG. 3, this routine is executed at intervals of a certain period of time, thus, when a determination in the step S504 is negative, the controller 50 terminates the routine immediately without waiting for the determination to turn to be positive.

In this case as well, the same result is obtained as with the case in which the processing of the step S505 is not performed until the determination in the step S305 is turned to be positive in the sub-routine of FIG. 3, since the processing of the step S505 is not performed until the determination in the step S504 is turned to be positive.

Even when air flows into the anode 7 during a normal operation of the fuel-cell power plant, the air is discharged to the outside, thus decrease of the electrical generation efficiency due to an inflow of the air can be prevented with the control as above.

In this embodiment, although the determination in the step S504 as to whether or not purging of air in the recirculation passage has been completed is based on the potential difference detected by the voltmeter 13, the determination may be performed based on the nitrogen concentration detected by the nitrogen sensor 21.

Further, with respect to the start-up control routine, the determinations in the steps S302 and S305 in FIG. 3 and the determinations in the steps S405 and S408 in FIG. 4 can be performed based on the nitrogen concentration detected by the nitrogen sensor 21. By making all of these determinations on the basis of the value detected by the nitrogen sensor 21, the voltmeter 13 can be omitted.

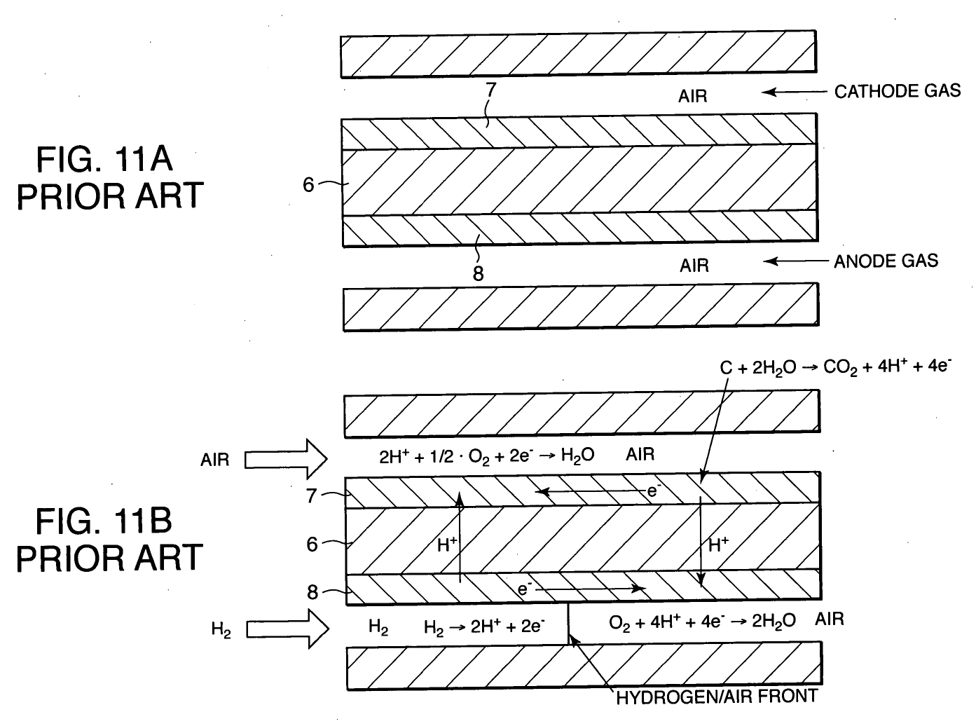

Next, referring to FIGS. 11A and 11B, a state in which the fuel-cell stack 1 is started up under the aforesaid prior art control will be discussed. If the fuel-cell stack 1 is not operative for a long time, air enters the anode 7 and cathode 8 from the outside as shown in FIG. 11A. The fuel-cell power plant is to be started up in this state.

According to the prior art control, hydrogen is supplied to the anode 7 in order to purge the residual air in the anode 7.

As a result, a gas flow around the anode 7 and a gas flow around the cathode 8 temporarily enter the state shown in FIG. 11B. Specifically, in the anode 7, air in a partial region is replaced with the hydrogen and air still remains in the rest of the region.

In a hydrogen region on the left side of the interface shown in FIG. 11B, the hydrogen in the anode 7 initiates the reaction represented in the above-described formula (1), a hydrogen ion H⁺ permeates the solid polymer electrolyte membrane 12 to reach the cathode 8, initiates the reaction represented in the above-described formula (2) in the cathode 8, and water is consequently generated. As a result, a potential of at least 0.8 volt is generated in the cathode 8.

On the other hand, in the gas flow region of the cathode 8 corresponding to a region on the right side of the interface in FIG. 11B, a carbon carrier that supports a platinum catalysts and water initiate a reaction shown in the following formula (6).
C+2H₂O→CO₂+4H⁺+4e⁻ (6)

This reaction is a cause of corrosion of the carbon carrier, of deteriorating the performance of the electrode catalyst layer of the cathode 8, and of lowering the performance of the fuel-cell stack 1. As a result of the reaction of the formula (6), the generated hydrogen ion H⁺ permeates the solid polymer electrolyte membrane 12 to reach the anode 7, and initiates a reaction represented in the following formula (7) in the anode 7 in the region on the right side of the interface of FIG. 11B.
O₂+4H⁺+4e⁻→2H₂O (7)

In order to prevent such deterioration of the fuel-cell stack 1, which is caused by the hydrogen-air interface, it is preferred that a large quantity of hydrogen be supplied to the anode 7, and that the residual air be purged in a short amount of time. However, a considerable portion of the hydrogen is discharged to the outside by such purging. Further, a high-output compressor is required to supply a large quantity of hydrogen to the anode 7 in a short amount of time. Moreover, increasing the flow of hydrogen to be supplied to the anode 7 increases energy losses due to the resistance of the flow passage, and reduces the whole energy efficiency of the fuel-cell power plant.

In this invention as well, when starting up the power plant after the non-operative state continues for a long time, the hydrogen of the hydrogen cylinder 5 is directly supplied to the fuel-cell stack 1, and the residual air in the anode 7 is discharged from the discharge passage 36 into the atmosphere.

However, in other cases for starting up the power plant, the anode effluent in the anode 7 is discharged into the atmosphere from the discharge passage 38 only after the separation of hydrogen in the hydrogen separator 2. Further, even in the former case, the potential difference between the anode 7 and cathode 8 is monitored and the discharge passage 36 is closed when the potential difference exceeds 0.8 volt, and a shift is made to the same processing as the latter performed by the hydrogen separator 2.

Therefore, the fuel-cell power plant is securely and promptly started up, and can minimize the chance that hydrogen is discharged to the atmosphere and the chance that the carbon carrier is corroded.

Furthermore, during a normal operation of the fuel-cell power plant, when the nitrogen concentration of the anode effluent discharged from the anode 7 of the fuel-cell stack 1 increases, the hydrogen concentration in the hydrogen rich gas supplied to the anode 7 is increased by the hydrogen pump function of the hydrogen separator 2. By this processing, the electric generation efficiency of the fuel-cell stack 1 is always maintained at a preferred level.

A second embodiment of this invention will now be described next.

The configuration of hardware of this embodiment is the same as that of the first embodiment. According to this embodiment the air retained in the anode 7 is replaced with hydrogen during a non-operative state of the fuel-cell power plant.

In this embodiment, even if the duration of the non-operative state of the fuel-cell power plant is long, when starting up the power plant, only the normal start-up control sub-routine of FIG. 3 is executed, and the sub-routine for a long-term non-operative state in FIG. 4 is not executed.

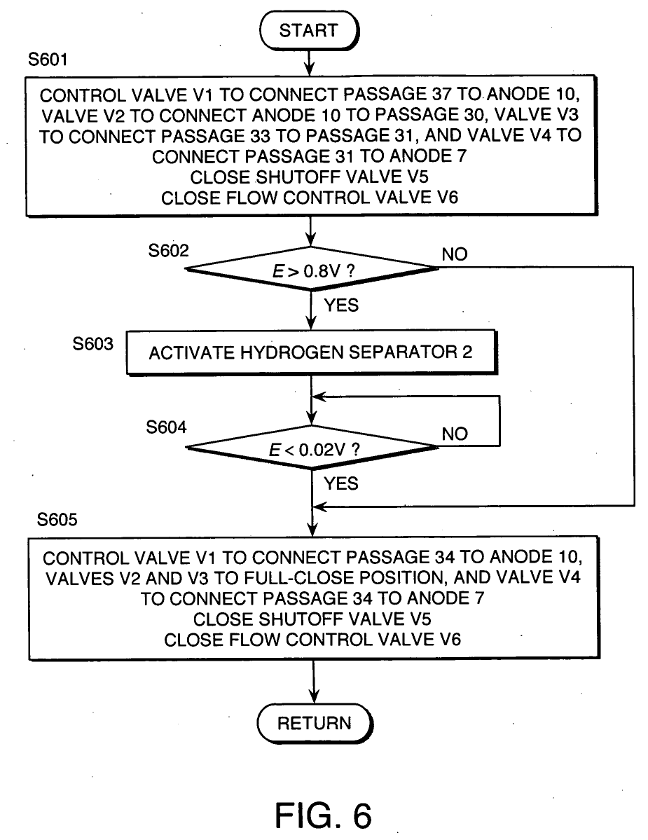

Referring to FIG. 6, a hydrogen replacement routine of anode according to the second embodiment of this invention, which is executed by the controller 50 during a non-operative state of the fuel-cell power plant will be described. In order to execute this routine, an electric power for operation is to be supplied from the secondary battery to the controller 50 during a non-operative state of the power plant.

The controller 50 measures a duration of a non-operative state of the fuel-cell power plant by means of a timer, and executes this routine every time the duration reaches a predetermined time. The predetermined time is set in a same way as the predetermined time of the first embodiment.

During a non-operative state of the fuel-cell power plant, it is assumed that the three way valve V1 connects the bypass flow passage 34 to the anode 10, the three way valve V2 connects the anode 10 to the flow passage 30, the three way valve V3 connects the cathode 11 to the flow passage 31, the three way valve V4 connects the flow passage 31 to the anode 7, and the shutoff valve V5 and the flow control valve V6 are both closed. The anode 7 and the hydrogen separator 2 therefore are shut off from the outside.

However, the three way valves V1 to V4, the shutoff valve V5, and the flow control valve V6 may be in positions other than those described above, as long as the anode 7 and the hydrogen separator 2 are shut off from the outside.

In a step S501, the controller 50 operates the three way valve V1 so as to connect the hydrogen cylinder 5 to the anode 10, and operates the three way valve V2 so as to connect the anode 10 to the discharge passage 38. The controller 50 further operates the three way valve V3 so as to connect the cathode 11 to the flow passage 31, and operates the three way valve V4 so as to connect the flow passage 31 to the anode 7.

In a following step S602, the controller 50 operates the mass flow control valve 18 to supply hydrogen in the hydrogen cylinder 5 to the anode 10 and detect a potential difference between the anode 10 and cathode 11 by means of the voltmeter 13. Since air is present in the cathode 11, when the hydrogen is supplied to the anode 10, a potential difference corresponding to the hydrogen concentration in the atmosphere of the anode 10 is generated between the anode 10 and cathode 11.

The controller 50 compares the potential difference between the cathode 11 and anode 10 with 0.8 volt, the potential difference being detected by the voltmeter 13, and, when the potential difference is large than 0.8 volt, performs the processing of a step S603. When the potential difference is not larger than 0.8 volt, the processing of a step S605 is performed.

The processing of the step S603 is the same as that of the step S304 of FIG. 2, and the processing of the step S604 is same as that of the step S305 of FIG. 2. As a result of the processings of the step S603 and of the step S604, the anode 7 is filled with hydrogen.

Although this routine is executed for each predetermined time as described above, a period of time before the determination in the step S604 is turned to be positive is sufficiently smaller than the predetermined time, thus there is no chance that a necessary time until the end of the routine exceeds the predetermined time by repeating the processings of the steps S603 and S604.

In a step S605, the controller 50 operates the three way valve V1 so as to connect the bypass flow passage 34 to the anode 10, operates the three way valve V2 so as to connect the anode 10 to the flow passage 30, operates the three way valve V3 so as to connect the cathode 11 to the flow passage 31, and operates the three way valve V4 so as to connect the flow passage 31 to the anode 7. Further, the controller 50 closes the shutoff valve V5 and the flow control valve V6.

The state realized by these operations corresponds to the non-operative state of the fuel-cell power plant.

By executing the above routines for each predetermined time, even when air flows into the anode 7 during a non-operative state of the fuel-cell power plant, the air in the anode 7 is replaced with hydrogen, and the atmosphere of the anode 7 can be maintained in a state which is appropriate for starting up the fuel-cell power plant. Therefore, it is not necessary to implement the sub-routine for a long-term non-operative state of FIG. 4 at the time of start-up.

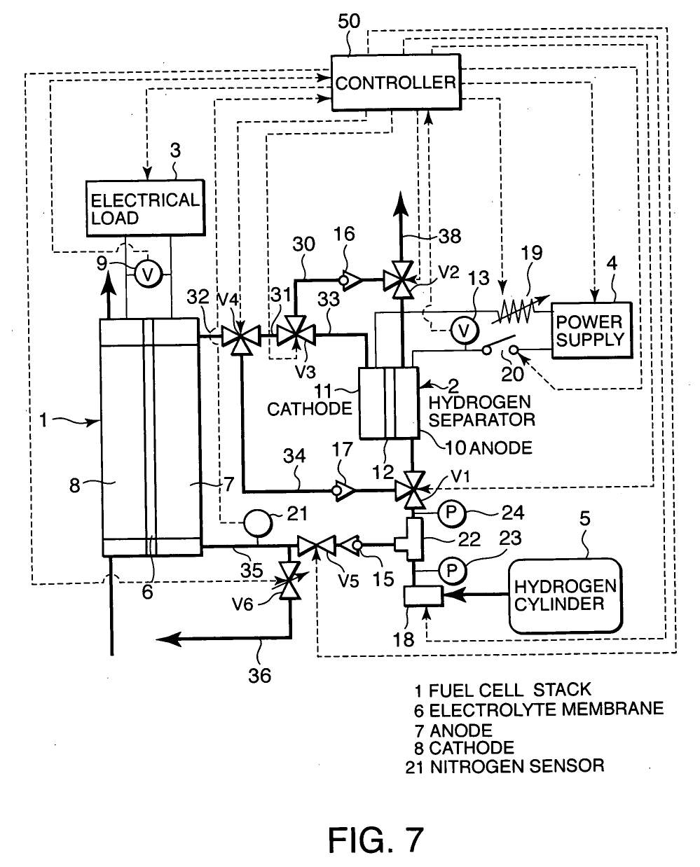

Referring to FIGS. 7 to 10, a third embodiment of this invention will be described.

Referring to FIG. 7, in this embodiment an ejector 22 is provided instead of the blower 14 of the first embodiment. Further, the power plant according to this embodiment comprises a pressure sensor 23 which detects a pressure of hydrogen flowing into the ejector 22, and a pressure sensor 24 which detects a gas pressure at an outlet of the ejector 22. Other configurations of the hardware are same as those of the first embodiment.

The pressure sensor 23 corresponds to the first pressure sensor in the claims and the pressure sensor 24 corresponds to the second pressure sensor in the claims.

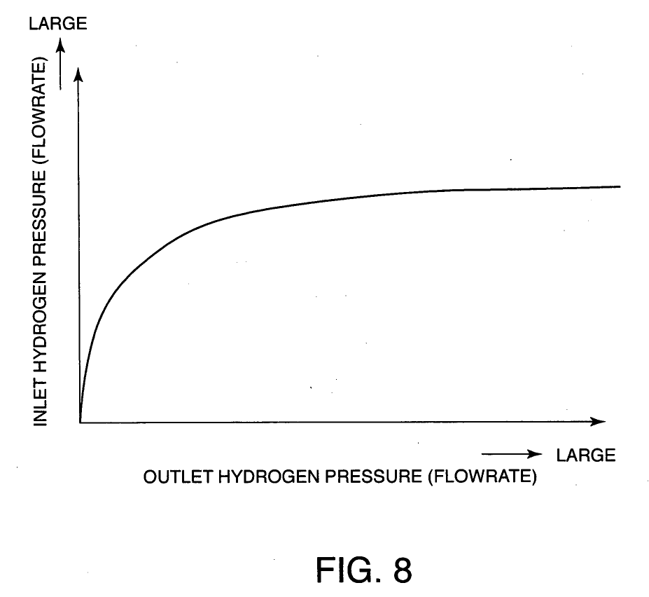

As a known characteristic of the ejector, the inlet pressure or the inlet flowrate of the ejector 22, and the outlet pressure or the outlet flowrate of the ejector 22 show the relationship illustrated in FIG. 8, providing that the diameter of the nozzle and the diameter of the diffuser inside the ejector 22 are constant.

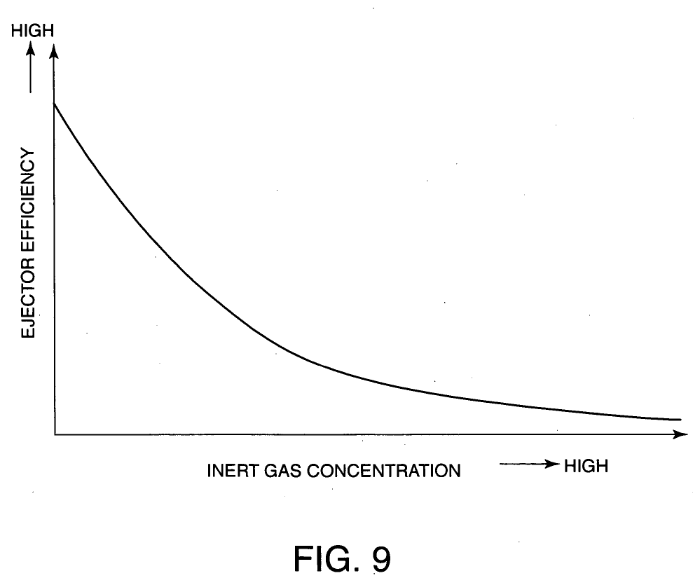

Specifically, when the inlet pressure or the inlet flowrate of the ejector 22 becomes large, the outlet pressure or the outlet flowrate also becomes large. However, when the air having nitrogen as a main component is mixed in the ejector 22 designed for hydrogen, the efficiency of the ejector 22 decreases as shown in FIG. 9, because the mass number of nitrogen is large, whereas the mass number of hydrogen is small.

Although the ejector 22 is used in this embodiment, a gas pump of mass control type may be used in stead of the ejector 22.

When starting up the fuel-cell power plant, the routine and the sub-routines which are executed by the controller 50 are substantially the same as those of the first embodiment. However, since the blower 14 is not present in this embodiment, operation of the blower 14 is not performed.

This embodiment is characterized by an air purge control routine, which is executed when the air concentration in the hydrogen rich gas supplied to the anode 7 becomes high during a normal operation of the fuel-cell power plant. For convenience of explanation, although an object to be purged is air, this routine can be applied for not only the air, but also for an increase of the concentration of any inert gas in the hydrogen rich gas.

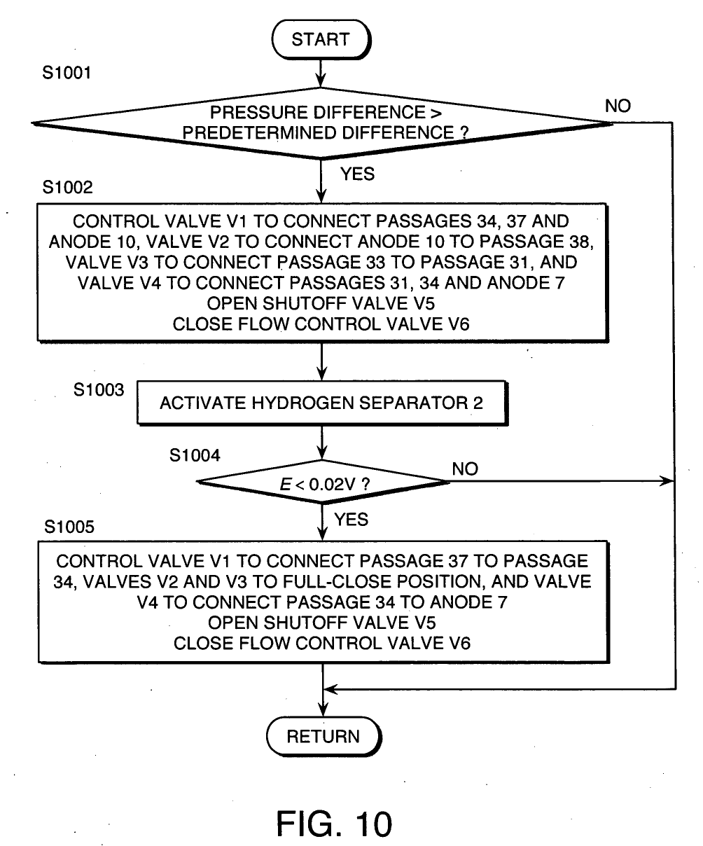

Referring now to FIG. 10, the air purge control routine will be described.

In a normal operation of the fuel-cell power plant, the three way valve V1 connects the hydrogen cylinder 5 to the bypass flow passage 34, the three way valve V4 connects the bypass flow passage 34 to the flow passage 32, the shutoff valve V5 is opened, and the flow control valve V6 is closed. Hydrogen which is supplied from the hydrogen cylinder 5 bypasses the hydrogen separator 2, and is supplied directly to the anode 7.

Anode effluent which is discharged from the anode 7 passes through the flow passage 35 and the three way valve V1, is mixed with the hydrogen supplied from the hydrogen cylinder 5 in the ejector 22, and thereafter is resupplied to the anode 7.

The three way valve V2 connects the anode 10 to the flow passage 30, and the three way valve V3 connects the flow passage 30 to the cathode 11.

As described hereintofore, the valves V2 and V3 may be kept at the full-close positions.

In a step S1001, the controller 50 calculates a pressure difference between an inlet pressure of the ejector 22 which is detected by the pressure sensor 23 and an outlet pressure of the ejector 22 which is detected by the pressure sensor 24, and compares the pressure difference with a predetermined pressure difference.

As a result, when the pressure difference exceeds the predetermined pressure difference, the controller 50 performs the processing of a step S1002. When the pressure difference does not exceed the predetermined pressure, the controller 50 immediately terminates the routine.

The predetermined pressure difference is determined as follows. Specifically, the pressure difference between the inlet and outlet of the ejector 22 depends on the hydrogen concentration of the anode effluent aspirated by the ejector 22. Then, a lower limit of the hydrogen concentration in the anode effluent is determined in advance by an experiment or simulation such that an electrical generation output of the fuel-cell stack 1 does not fall below the lower limit, and the corresponding pressure difference is set to the predetermined pressure.

Since the processings of steps S1002 to S1005 are the same as those of the steps S502 to S505 in FIG. 5 of the first embodiment, the explanations are omitted here.

In this embodiment, the hydrogen concentration in the hydrogen-containing gas supplied to the anode 10 is determined from the potential difference between the anode 10 and the cathode 11 in the step S1004. However, the determination may be performed based on the pressure difference between the inlet and outlet of the ejector 22. Specifically, when the pressure difference falls below a predetermined pressure difference, the hydrogen pump function of the hydrogen separator 2 in the steps S1002 and S1003 is stopped.

According to this embodiment, it is possible to minimize the chance that hydrogen is discharged to the atmosphere and the chance that the carbon carrier is corroded, while securing quick start-up of the fuel-cell power plant, as in the case of the first embodiment, but without using the blower 14.

This embodiment can be combined with the second embodiment.

This embodiment relates to the processing when the hydrogen concentration in the anode effluent decreases in a normal operation of the fuel-cell power plant. Therefore, at the time of start-up of the fuel-cell power plant, the routine and sub-routines in FIGS. 2 to 4 by the first embodiment can be applied. In this case, the determinations in the S302 and S305 in FIG. 3, and the determinations in the S405 and S408 in FIG. 4 can be performed based on the pressure difference between the inlet and outlet of the ejector 22. By performing these determinations based on the pressure difference between the inlet and outlet of the ejector 22, the voltmeter 13 can be omitted.

The contents of Tokugan 2004-114256, with a filing date of Apr. 8, 2004 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

For example, in the above embodiments, the parameters required for control are detected using sensors, but this invention can be applied to any device which can perform the claimed control using the claimed parameters regardless of how the parameters are acquired.

The embodiments of this invention in which an exclusive property or privilege is claimed are defined as follows:

1. A fuel-cell power plant comprising:
a fuel-cell stack which generates electricity by an electrochemical reaction of hydrogen which is supplied to an anode and an oxidant which is supplied to a cathode;
a hydrogen supply device which supplies hydrogen to the anode;
a recirculation passage which recirculates an anode effluent discharged from the anode, to the anode;
a hydrogen separator disposed in the recirculation passage to separate hydrogen from the anode effluent, the hydrogen separator comprising a discharge passage for discharging the anode effluent after separation of hydrogen to the outside of the power plant;
a bypass flow passage which detours the hydrogen separator and directly connects the recirculation passage to the anode; and
a valve which selectively connects the recirculation passage to the hydrogen separator and to the bypass flow passage.

2. The power plant as defined in claim 1, wherein the power plant further comprises a sensor which detects a hydrogen concentration of the anode effluent, and a programmable controller programmed to control the valve according to the hydrogen concentration of the anode effluent.

3. The power plant as defined in claim 2, wherein the controller is further programmed to cause the valve to connect the recirculation passage to the bypass flow passage when the hydrogen concentration is higher than or equal to a first predetermined concentration.

4. The power plant as defined in claim 2, wherein the controller is further programmed to cause the valve to supply a part of the anode effluent to the hydrogen separator when the hydrogen concentration is lower than the firs predetermined concentration.

5. The power plant as defined in claim 4, wherein the controller is further programmed to cause the valve to supply all the anode effluent to the bypass flow passage when the hydrogen concentration is higher than a second predetermined concentration which is higher than the first predetermined concentration.

6. The power plant as defined in claim 2, wherein the hydrogen supply device is configured to supply hydrogen to the recirculation passage.

7. The power plant as defined in claim 6, wherein the hydrogen separator comprises an electrolyte membrane which transmits only a hydrogen ion, a second anode and a second cathode which are disposed on both sides of the electrolyte membrane, a power supply device which supplies electric power to the second anode and the second cathode to electrically separate the hydrogen ion from a gas flowing into the second anode from the recirculation passage, a passage which connects the second cathode and the anode of the fuel-cell stack, and a discharge passage which discharges the gas after separating the hydrogen ion in the second anode into the atmosphere.

8. The power plant as defined in claim 7, wherein the power plant further comprises a switch which cuts off power supply of the power supply device, and wherein the sensor comprises a voltmeter which detects a potential difference between the second anode and the second cathode in a state in which the switch cuts off power supply of the power supply device.

9. The power plant as defined in claim 8, wherein the controller is further programmed to determine that the hydrogen concentration is hither than or equal to the first predetermined concentration when the potential difference detected by the voltmeter is 0.8 volt or lower.

10. The power plant as defined in claim 8, wherein the controller is further programmed to determine that the hydrogen concentration is higher than the second predetermined concentration when the potential difference detected by the voltmeter is lower than 0.02 volt.

11. The power plant as defined in claim 6, wherein the controller is further programmed to measure a duration of a non-operative state of the fuel-cell stack, and, when the duration has exceeded a predetermined time period, to cause the valve to connect the recirculation passage to the bypass flow passage when the fuel-cell stack starts to operate.

12. The power plant as defined in claim 11, wherein the power plant further comprises a second valve which discharges the anode effluent into the atmosphere, and the controller is further programmed to cause the second valve to discharge the anode effluent into the atmosphere when the when the fuel-cell stack starts to operate, when the duration exceeds the predetermined time period.

13. The power plant as defined in claim 11, wherein the power plant further comprises a second voltmeter which detects a potential difference between the anode of the fuel-cell stack and the cathode of the fuel-cell stack, and the controller is further programmed to cause the second valve to stop discharging the anode effluent into the atmosphere when the potential difference detected by the second voltmeter exceeds a predetermined potential difference.

14. The power plant as defined in claim 6, wherein the controller is further programmed to measure a duration of a non-operative state of the fuel-cell stack, to cause the valve to connect the recirculation passage to the hydrogen separator and to cause the hydrogen supply device to supply hydrogen to the recirculation passage, while causing the fuel-cell stack to continue the non-operative state, when the duration has exceeded a predetermined time period.

15. The power plant as defined in claim 7, wherein the sensor comprises a nitrogen sensor which detects a nitrogen concentration in the anode effluent, and the controller is further programmed to determine the hydrogen concentration of the anode effluent based on the nitrogen concentration.

16. The power plant as defined in claim 7, wherein the sensor comprises a first pressure sensor which detects a pressure of hydrogen in the recirculation passage before mixing with the anode effluent and a second pressure sensor which detects a pressure of a mixed gas of the anode effluent and the hydrogen in the recirculation passage, and the controller is further programmed to determine the hydrogen concentration based on a pressure difference between a pressure detected by the first pressure sensor and a pressure detected by the second pressure sensor.

17. The power plant as defined in claim 1, wherein the power plant further comprises an ejector which aspirates the anode effluent into the recirculation passage according to a flow of the hydrogen supplied from the hydrogen supply device to the recirculation passage.
